(19) United States
(12) Patent Application Publication
(10) Pub. No.: US 2013/0167851 A1
(43) Pub. Date: Jul. 4, 2013

(54) METHOD OF FILTER ASSEMBLY FOR SMOKING ARTICLE

(71) Applicants: Balager Ademe, Winston-Salem, NC (US); Evon L. Crooks, Mocksville, NC (US); Robert L. Oglesby, Kernersville, NC (US)

(72) Inventors: Balager Ademe, Winston-Salem, NC (US); Evon L. Crooks, Mocksville, NC (US); Robert L. Oglesby, Kernersville, NC (US)

(21) Appl. No.: 13/338,647

(22) Filed: Dec. 28, 2011

(51) Int. Cl. A24D 1/04; B31C 99/00; A24C 5/47

(52) U.S. Cl. 131/280; 131/331; 131/337; 493/39

(57) ABSTRACT

A method is provided for manufacturing a filter of a filtered smoking article, where the filter material includes a fluid-releasing body. The method provides a fluid-resistant barrier between the filter material and plug wrap encompassing the filter material, where the barrier is applied as a hot melt adhesive. In other aspects, mechanisms for using the method are provided.

### TECHNICAL FIELD

The present invention relates to products made or derived from tobacco, or that otherwise incorporate tobacco, and are intended for human consumption. Certain embodiments of the present invention relate to smoking articles including flavor-releasing filter components. More particularly, embodiments of the present invention may relate to structures, methods, and devices related to filter-wrapping and to tipping (combining a filter with a tobacco rod) methods used during manufacture of smoking articles.

### BACKGROUND

Popular smoking articles, such as cigarettes, have a substantially cylindrical rod shaped structure and include a charge, roll or column of smokable material such as shredded tobacco (e.g., in cut filler form) surrounded by a paper wrapper thereby forming a so-called “smokable rod” or “tobacco rod.” Normally, a cigarette has a cylindrical filter element aligned in an end-to-end relationship with the tobacco rod. Typically, a filter element comprises cellulose acetate tow plasticized using triacetin, and the tow is circumscribed by a paper material known as “plug wrap.” A cigarette can incorporate a filter element having multiple segments, and one of those segments can comprise activated charcoal particles. See, for example, U.S. Pat. No. 6,537,186 to Veluz; PCT Publication No. WO 2006/064371 to Banerjea; and U.S. Pat. App. Pub. No. 2007/0056600, to Coleman III, et al.; each of which is incorporated herein by reference. Typically, the filter element is attached to one end of the tobacco rod using a circumscribing wrapping material known as “tipping paper.” It also has become desirable to perforate the tipping material and plug wrap, in order to provide dilution of drawn mainstream smoke with ambient air. Descriptions of cigarettes and the various components thereof are set forth Tobacco Production, Chemistry and Technology, Davis et al. (Eds.) (1999). A cigarette is employed by a smoker by lighting one end thereof and burning the tobacco rod. The smoker then receives mainstream smoke into his/her mouth by drawing on the opposite end (e.g., the filter end) of the cigarette.

The sensory attributes of cigarette smoke can be enhanced by applying additives to tobacco and/or by otherwise incorporating flavoring materials into various components of a cigarette. See, Leffingwell et al., Tobacco Flavoring for Smoking Products, R.J. Reynolds Tobacco Company (1972). For example, one type of tobacco flavoring additive is menthol. See, Borschke, Rec. Adv. Tob. Sci., 19, p. 47-70, 1993. Various proposed methods for modifying the sensory attributes of cigarettes include certain filter elements that may be used for adding flavor to the mainstream smoke of those cigarettes. U.S. Pat. No. 6,761,174 to Jupe et al. proposes the placement of adsorbent and flavor-releasing materials in a cigarette filter. U.S. Pat. No. 6,584,979 to Xue et al. proposes the placement of fibers containing small particle size adsorbents/absorbents in the filter. U.S. Pat. No. 4,941,486 to Dube et al. and U.S. Pat. No. 4,862,905 to Green, Jr. et al., which are incorporated herein by reference, propose manners and methods for the placement of a flavor-containing pellet in each cigarette filter. Other representative types of cigarette filters incorporating flavoring agents are set forth in U.S. Pat. No. 3,972,335 to Tiggelbeck et al.; U.S. Pat. No. 4,082,098 to Owens, Jr.; U.S. Pat. No. 4,281,671 to Bynre; U.S. Pat. No. 4,729,391 to Woods et al.; U.S. Pat. No. 4,768,526 to Pryor; U.S. Pat. No. 5,012,829 to Thesing et al.; U.S. Pat. No. 5,387,285 to Rivers; and U.S. Pat. No. 7,074,170 to Lanier, Jr. et al.; and each of which is incorporated herein by reference. See, also, the types of cigarette filter technologies that are discussed in the background art section set forth in U.S. Pat. No. 7,836,895 to Dube et al.; which is incorporated herein by reference.

It would be highly desirable to provide a smoker with the ability to enhance his/her smoking experience, such as can be accomplished by providing a filtered cigarette including a filter element having particular design features. That is, it would be desirable to provide a cigarette including filter components that are employed in a manner such that the filter element is aesthetically pleasing. It also would be desirable to provide such a filter element including selected design features that can be modified or otherwise controlled. In addition, it would be desirable to provide a filter element for a cigarette that is capable of enhancing the sensory attributes of the mainstream smoke (e.g., by flavoring the mainstream smoke) produced by that cigarette. Flavor enhancing materials disposed in a filter may include liquid or other flowable composition, such that it may be desirable to provide one or more barrier structures to prevent flowable material from passing through plug wrap and/or tipping material disposed around the filter.

### BRIEF SUMMARY

The above and other needs are met by embodiments disclosed here, which provide apparatuses and methods for manufacturing filter rods for use in the manufacture of smoking articles, such as cigarettes. Filter rods may be produced such that each such rod includes one or more flavor-enhancing materials that are contained and that may be released by a user. Filter rods containing such materials may be provided with a barrier layer of a hot-melt adhesive between filter tow and encompassing plug wrap that will prevent or at least minimize the likelihood of the flavor-enhancing material(s) passing through the plug wrap. Filter rods, which may or may not contain flavor-enhancing materials, can be assembled to wrapped tobacco rods using an improved tipping process that provides adhesive to the tipping material in an effective manner minimizing maintenance and increasing manufacturing efficiency.

### BRIEF DESCRIPTION OF THE DRAWINGS

FIG. 1 is an exploded perspective of smoking article, showing the smokable material, the wrapping material components, and the filter element;

FIG. 2 is a cross-sectional view of a filter element incorporating an adsorbent material therein according to one embodiment of the present invention;

FIG. 3 is a cross-sectional view of a smoking article having the form of a cigarette, showing smokable material, wrapping material components, and a filter element including a releasable material;

FIG. 4 is a generally diagrammatic view of a filter rod-making apparatus;

FIG. 5 is a generally diagrammatic view of a prior art tipping apparatus; and

FIG. 6 is a generally diagrammatic view of a tipping apparatus using a nozzle applicator assembly.

### DETAILED DESCRIPTION

Embodiments are described with reference to the drawings. The relationship and functioning of the various elements of the embodiments may better be understood by reference to the following detailed description. However, embodiments are not limited to those illustrated in the drawings. It should be understood that the drawings are not necessarily to scale, and in certain instances details may have been omitted that are not necessary for an understanding of embodiments of the present invention, such as—for example—conventional fabrication and assembly.

Various embodiments will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise. Reference to “dry weight percent” or “dry weight basis” refers to weight on the basis of dry ingredients (i.e., all ingredients except water).

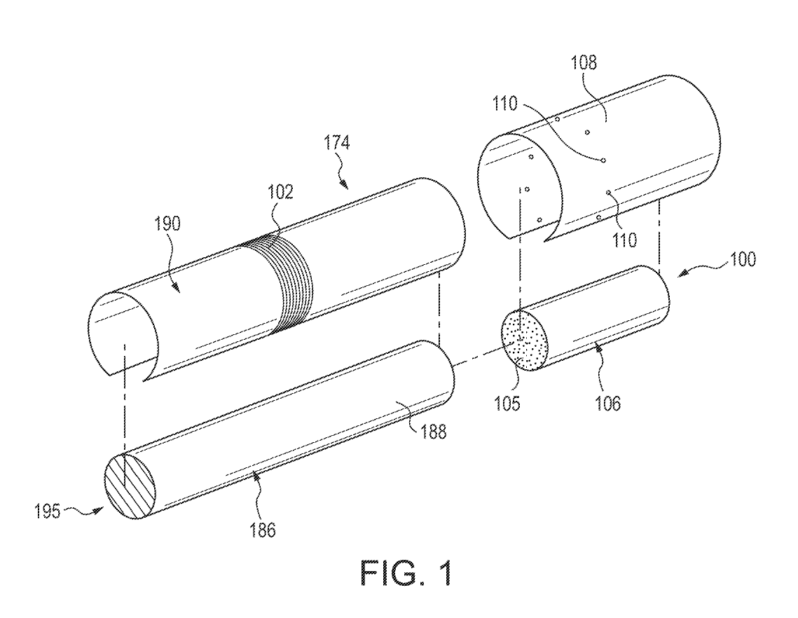

A typical smoking article in the form of a cigarette 174 is illustrated with reference to FIG. 1. The cigarette 174 includes a generally cylindrical rod 186 of a charge or roll of smokable filler material 188 contained in a circumscribing wrapping material 190 of the present invention. The rod 186 is conventionally referred to as a “tobacco rod”. The ends of the tobacco rod are open to expose the smokable filler material. At one end of the tobacco rod 186 is the lighting end 195, and at the other end is shown a filter element 100. The cigarette 174 is shown as having one optional band 102 printed on wrapping material 190, and that band entirely circumscribes the cigarette rod in a direction transverse to the longitudinal axis of the cigarette. That is, the band 102 provides a cross-directional region relative to the longitudinal axis of the cigarette 174. The band 102 may be applied to the inner surface of the wrapping material 190 (i.e., facing the smokable filler material), or may be applied to the outer surface of the wrapping material 190. Although the cigarette 174 shown in FIG. 1 has wrapping material having one band, the cigarette also can include wrapping material having two, three, or more spaced bands. The band 102 may include a water-based coating formulation that affects ignition potential of the coated wrapping paper portion.

The cigarette 174 commonly includes a filter element 100 or other suitable mouthpiece positioned adjacent one end of the tobacco rod 186 such that the filter element and tobacco rod are axially aligned in an end-to-end relationship, abutting one another. Filter element 100 has a generally cylindrical shape, and the diameter thereof is essentially equal to the diameter of the tobacco rod. The ends of the filter element are open to permit the passage of air and smoke therethrough. The filter element 100 includes filter material 105 (e.g., plasticized cellulose acetate tow) that is overwrapped along the longitudinally extending surface thereof with circumscribing plug wrap material 106. The filter element 100 can have two or more filter segments, and/or flavor additives incorporated therein.

The filter element 100 is attached to the tobacco rod 186 by tipping material 108 which circumscribes both the entire length of the filter element and an adjacent region of the tobacco rod. The inner surface of the tipping material 108 is secured to the outer surface of the plug wrap 106 and the outer surface of the wrapping material 190 of the tobacco rod using a suitable adhesive. A ventilated or air-diluted smoking article may be provided with an air-dilution means, such as a series of perforations 110, each of which extends through the tipping material and underlying plug wrap.

Certain types of smoking articles may include filter elements that incorporate objects, such as breakable capsules. Various components of such filter elements, as well as equipment and techniques for manufacturing such filter elements, are set forth, for example, in U.S. Pat. Nos. 7,479,098 to Thomas et al.; 7,833,146 to Deal; 7,836,895 to Dube et al.; and 7,972,254 to Stokes et al.; U.S. Pat. Pub. Nos. 2008/0142028 to Fagg; 2009/0050163 to Hartmann et al.; 2009/0090372 to Thomas et al.; 2010/0184576 to Prestia et al.; 2010/0236561 to Barnes et al.; 2011/0053745 to Iliev et al.; and PCT App. Pub. No. WO 03/009711 to Kim; each of which is incorporated herein by reference. Exemplary capsules can be of the type employed commercially in cigarettes marketed under the brand name Camel Crush by R. J. Reynolds Tobacco Company.

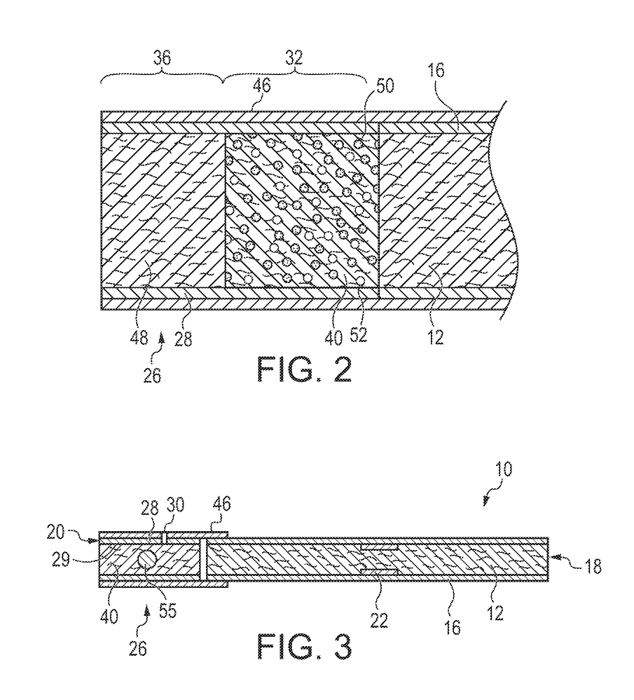

In some instances, a filter element 26 may be configured as shown in FIG. 2, wherein the filter includes a first filter segment 32 positioned adjacent one end of the tobacco rod 12. The first filter segment 32 includes filter material 40 (e.g., cellulose acetate tow impregnated with plasticizer, such as triacetin). In other instances, the filter element 26 may not be divided into segments, such as shown in FIG. 3. With continuing reference to FIG. 2, within the filter material 40 of the first segment may be inserted an adsorbent material/particulate or an object configured for actuatable release of flavor (e.g., a rupturable or breakable capsule), designated here as object/material 50. In certain embodiments where a carbonaceous material is used as an adsorbent material 50, at least a portion of the carbonaceous material, and typically virtually all of the carbonaceous material, is in intimate contact with an effective amount of a mixture of polyol ester (e.g., triacetin) and polyol (e.g., propylene glycol). If desired, the filter element also can be incorporate other components that have the ability to alter the properties of the mainstream smoke that passes throughout the filter element. See, for example, U.S. Pat. Application Publication Nos. 2004/0237984 to Figlar et al.; 2005/0268925 to Schluter et al.; 2006/0130861 to Luan et al.; and 2006/0174899 to Luan et al., which are incorporated herein by reference.

The filter element 26 may also possess a second filter segment 36 longitudinally disposed relative to the first segment 32 and positioned at the extreme mouth end of the cigarette 10. The second filter segment 36 includes filter material 48 (e.g., cellulose acetate tow impregnated with plasticizer, such as triacetin) that is over-wrapped along the longitudinally extending surface thereof with circumscribing plug wrap material 28. The second filter segment 36 may be substantially free of adsorbent and breakable or rupturable capsules, meaning that such additives are not visible when viewing the extreme mouth end of the filter element 26.

The filter element 26 is circumscribed along its outer circumference or longitudinal periphery by a layer of outer plug wrap 28. The outer plug wrap 28 overlies each of the first filter segment 32 and the second filter segment 36, so as to provide a combined, two-segment filter element.

The filter element 26 is attached to the tobacco rod 12 using tipping material 46 (e.g., essentially air impermeable tipping paper), that circumscribes both the entire length of the filter element 26 and an adjacent region of the tobacco rod 12. The inner surface of the tipping material 46 is fixedly secured to the outer surface of the plug wrap 28 and the outer surface of the wrapping material 16 of the tobacco rod, using a suitable adhesive; and hence, the filter element and the tobacco rod are connected to one another. See also the tipping materials and configurations set forth in U.S. Pat. Publication No. 2008/0029111 to Dube et al., which is incorporated by reference herein.

A ventilated or air diluted smoking article can be provided with an optional air dilution mechanisms, such as a series of perforations 30, each of which extend through the tipping material and plug wrap. The optional perforations 30, shown in FIG. 3, can be made by various techniques known to those of ordinary skill in the art, such as laser perforation techniques. Alternatively, so-called off-line air dilution techniques can be used (e.g., through the use of porous paper plug wrap and pre-perforated tipping paper). For cigarettes that are air diluted or ventilated, the amount or degree of air dilution or ventilation can vary. Frequently, the amount of air dilution for an air diluted cigarette is greater than about 10 percent, generally is greater than about 20 percent, often is greater than about 30 percent, and sometimes is greater than about 40 percent. Typically, the upper level for air dilution for an air diluted cigarette is less than about 80 percent, and often is less than about 70 percent. As used herein, the term “air dilution” is the ratio (expressed as a percentage) of the volume of air drawn through the air dilution means to the total volume and air and smoke drawn through the cigarette and exiting the extreme mouth end portion of the cigarette.

During use, the smoker lights the lighting end 18 of the cigarette 10 using a match or cigarette lighter. As such, the smokable material 12 begins to burn. The mouth end 20 of the cigarette 10 is placed in the lips of the smoker. Thermal decomposition products (e.g., components of tobacco smoke) generated by the burning smokable material 12 are drawn through the cigarette 10, through the filter element 26, and into the mouth of the smoker. During draw, certain amount of certain gaseous components of the mainstream smoke may be removed from the mainstream smoke or neutralized within the filter element 26. Filters incorporating adsorbent material, such as carbonaceous filter components (e.g., activated charcoal particles) have the capability of capturing a wide range of mainstream tobacco smoke vapor phase components. If desired, prior to, during or after the smoking experience, the smoker can optionally squeeze the filter element. As a result, at least a portion of breakable capsules in the filter can be broken, and hence release a flavoring agent contained therein, which may be in particulate and/or liquid form.

The dimensions of a representative cigarette 10 can vary. Preferred cigarettes are rod shaped, and can have diameters of about 7.5 mm (e.g., circumferences of about 20 mm to about 27 mm, often about 22.5 mm to about 25 mm); and can have total lengths of about 70 mm to about 120 mm, often about 80 mm to about 100 mm. The length of the filter element 30 can vary. Typical filter elements can have total lengths of about 15 mm to about 40 mm, often about 20 mm to about 35 mm. For a typical dual-segment filter element, the downstream or mouth end filter segment often has a length of about 10 mm to about 20 mm; and the upstream or tobacco rod end filter segment often has a length of about 10 mm to about 20 mm.

As illustrated in FIG. 2, one filter element 26 that may be formed in accordance with the present invention comprises multiple, longitudinally-extending segments. Each segment can have varying properties and may include various materials capable of filtration or adsorption of particulate matter and/or vapor phase compounds from the mainstream smoke. Typically, the filter element of various aspects of the invention includes 2 to 6 segments, frequently 2 to 4 segments. In some instances, the filter element 26 may include a mouth end segment and a tobacco end segment, with the tobacco end segment comprising a dispersed adsorbent material 50 and a flavoring agent 52.

As shown in FIG. 2, the filter element may incorporate an adsorbent material/particulate or other object 50. An adsorbent material 50 may be a material with relatively high surface area capable of adsorbing smoke constituents without a high degree of specificity, or a material that adsorbs certain compounds with a greater degree of specificity, such as an ion exchange resin. Exemplary types of adsorbent material may include activated carbon, a molecular sieve (e.g., zeolites and carbon molecular sieves), clay, an ion exchange resin, activated alumina, silica gel, meerschaum, and combinations thereof. Any adsorbent material, or mixture of materials, that has the ability to alter the character or nature of mainstream smoke passing through the filter element may be used.

As shown, for example, in FIG. 3, an adsorbent or other material may be included in a carrier 55 within a filter element 26 (or a continuous filter rod before longitudinal severance thereof to form multiple filter elements 26). Selection of a suitable carrier material 55 may facilitate, for example, improved production by more effectively and efficiently inserting the now “captive” adsorbent material into the filter element 26. That is, the adsorbent material (or another non-adsorbent material) is carried by the carrier material 55 upon insertion thereof into the filter element 26. In some embodiments, the carrier material 55 may be in the form of, for example, a pellet, a capsule, a tube, a continuous elongate structure, a continuous strip, a strand, or any like structure capable of receiving and “holding captive” a desired material so as to facilitate insertion thereof into the filter element 26. In some embodiments, individual or multiple forms of a carrier 55 may be inserted into the filter element 26. For example, individual or multiple capsules, tubes, pellets, etc. or combinations thereof may be inserted into the filter element 26 in accordance with various aspects of different embodiments. In one embodiment, the carrier 55 may be embodied as a rupturable or otherwise breakable capsule containing a flowable material (which may, for example, include flavorant material in a fluid, gel, or other flowable form). Various embodiments may include methods and structures disclosed in U.S. Pat. Nos. 7,740,019 to Nelson et al.; 7,794,665 to Dube et al.; and U.S. Pat. App. Pub. No. 2009/0288667 to Andresen et al., each of which is incorporated herein by reference.

After insertion of a carrier 55 into the continuous rod of filter material, the adsorbent or other material contained therein may be released from the carrier and into the filter material. For example, the carrier 55 may be dissolved, disintegrated, degraded, or otherwise destroyed so as to release and/or disperse the adsorbent material 50 into the filter material so as to allow an adsorbent material 50 to have the desired effect on the mainstream smoke drawn through the filter element. The release of the adsorbent material into the filter material may occur before or after the continuous rod has been severed into filter segments (e.g., filter element 26). Such release can occur during the manufacturing process or, in some instances, may be effectuated by the smoker prior to smoking the smoking article. In some instances, various forms of the adsorbent or other material (i.e., strands, beads, pellets, capsules, or combinations thereof) may be disposed in a closed cell foam as a carrier material 55, wherein, once inserted into a filter element 20, may be irradiated or heated to break down the foam and release the adsorbent or other contained material therefrom. Alternately, a carrier material 55 may comprise an open cell foam, wherein, for example, air and/or physical force may be used to release the adsorbent material 50 once the object is inserted into the filter element 20. In these or other embodiments, a carrier material 55 may be provided, for example, in the form of a breakable capsule, a “capsule-in-capsule,” or a strand, formed of a water- or other liquid-soluble polymer and configured to carry an adsorbent or other material (such as, e.g., a flavorant material). Such a soluble polymer may comprise, for example, polylactic acid, polyvinyl alcohol (PVA), starches and/or starch-based polymers, carrageenans, polyvinyl acetate, hydroxypropylcellulose, pullulan, carboxymethylcellulose and its salts (i.e., alkali metal salts), alginates and their salts, gelatin, and/or any other suitable polymers or combinations thereof.

In embodiments where a capsule or other breakable container 50 and/or 55 of a releasable adsorbent or other material is provided, such material may be in a liquid or other flowable form. In such embodiments, it may be desirable to decrease the likelihood that the released material will wick, seep, or otherwise travel through the plug wrap and tipping paper overlying the filter material containing it (e.g., where it would potentially directly contact a user's lips, fingers, or other external object). Specialized liquid-barrier plug wrap papers have been used for this purpose in some products. However, some liquid-barrier plug wrap papers may be more costly than standard plug wrap. For at least this reason, it may be desirable to provide lower-cost solutions using standard plug wrap paper materials.

Indeed, doing so may provide (i) an effective barrier against material from a ruptured capsule or other container may be formed by a hot-melt material that also adheres standard plug wrap around filter material; and (ii) the implementation of a method of hot-melt barrier adhesive may provide a filter assembly that prevents passage of capsule material through the plug wrap at least as effectively as barrier plug wrap materials. This may result in cost reduction as compared to fluid-barrier plug wrap materials.

In one embodiment, an adhesive and/or a hot melt material may be applied over all, substantially all, or a large portion of the surface interface between filter material 40 and overlying plug wrap 28 (e.g., by application to the plug wrap before the plug wrap is applied and adhered thereby to the filter material to form a filter plug). The adhesive and/or a hot melt material may thus serve a dual purpose of adhering the plug wrap 28 to the filter material 40 while simultaneously providing a barrier layer of adhesive 29 (shown in FIG. 3 much larger than actual scale) against flowable material wicking, seeping, or otherwise passing through the plug wrap and tipping material overlying the filter 40. Methods, materials, and mechanisms generally applicable to application of adhesives and/or other materials are disclosed in U.S. Pat. No. 7,237,557 to Maiwald, et al., which is incorporated herein by reference.

For a typical cigarette, the surface interface between the plug wrap 28 and the filter material 40 will often only have a discontinuous adhesive layer. In a cigarette incorporating a breakable capsule configured to release a liquid or other flowable material, this structure will often be insufficient form a barrier that will effectively prevent the liquid or other flowable material from traveling to and through the plug wrap and tipping material to the cigarette's exterior. However, applying a hot melt material in keeping with the presently disclosed method may provide an effective barrier against the liquid or other flowable material.

Suitable adhesives and/or hot melt materials may include, for example, material bearing National Starch code #10110160.

The adhesives and/or hot melt material(s) may be applied over the entire interface surface. One or both may each be applied to the outward-facing filter surface, the filter-facing plug wrap surface, or both. It may generally be preferable to apply the material(s) to the plug wrap. It may also be useful in certain embodiments to apply the adhesives and/or hot melt material(s) to the tipping material. The application need not cover the entire interface surface or any entire surface (e.g., of filter material, plug wrap, or tipping material). The adhesives and/or hot melt material(s) may be applied in one or more regular or irregular patterns, patches, seams, bands, or any other manner providing surface coverage. In certain embodiments, the adhesives and/or hot melt materials may be applied by “printing-type” transfer from a roller. However, certain advantages may be gained by applying the adhesives and/or hot melt material(s) via nozzles that can strictly control flow rate, volume, and placement. Mechanical and/or digital control of the nozzles may be used to provide careful metering (such as, for example, pulsing or other controlled release) of the material(s). One example of an apparatus that may be used for an online or offline application of adhesive (e.g., glue, hot melt) is the Baumer Xmelt HHS.

The adhesives and/or hot melt material(s) may be applied during filter formation, and/or may be applied during an earlier or a later phase allowing placement of the material(s) between the filter material exterior and the filter-facing surface of the plug wrap. Placement of the material(s) by nozzle may provide certain advantages over the printer-type roller placement that can be used to apply adhesive and/or adhesive-type materials to plug wrap, tipping material, and/or other smoking article components. For example, material may accumulate on the rollers (e.g., based upon early curing due to temperature variations, viscosity changes, or other factors) and require downtime for cleaning/conditioning. By contrast, the ability to heat the nozzles, vary their aperture size, and even swap out nozzle heads in a manner more efficient that cleaning or exchanging rollers may provide advantages that will be appreciated by those having skill in the art.

Exacting control of the hot-melt material application can be achieved, and preferably will be implemented, using a computerized and/or mechanical control that actively correlates the material flow through the nozzles to the speed of the paper being fed past the nozzles. Specifically, a rotary encoder can be provided on the paper-feeding portion of an assembly machine (e.g., Hauni Max 80 and KDF2), where the rotary encoder communicates with the hot-melt dispenser (e.g., Baumer hhs) to increase or decrease flow of hot-melt material through the nozzles to provide the desired barrier-forming layer, correlated to the speed at which a ribbon or other shaped supply of plug wrap paper is being directed past the nozzles. In this manner, the density of surface application (e.g., grams of adhesive per unit area), as well as the total amount being applied can carefully be controlled. Preferably, a generally continuous layer will be formed when treating the plug wrap (by applying the hot-melt material) that will serve as an effective barrier. The preferably continuous layer may be applied as a continuous layer onto the plug wrap, or it may be applied as a discontinuous layer that is patterned or unpatterned, but is configured to form a continuous and effective barrier layer between the filter material and the plug wrap when the treated plug wrap is applied around the capsule-containing filter material to form a finished or near-finished filter.

For an effective barrier, about 1.8 to about 2.2 grams of hot-melt may be applied per linear meter of standard plug wrap material. In one embodiment, an effective barrier layer may be formed by applying about 2 grams of hot-melt per linear meter of standard plug wrap material, where the barrier is formed when the plug wrap is assembled to form a filter (e.g., a typical solid-cylinder filter with a cellulose acetate core, or another filter material, where the preferred use of this method will be with a filter containing a breakable capsule or other breakable container that releasably contains a flowable flavorant or other material configured for user-actuated release into the filter material). For example, the hot melt adhesive may be applied at a generally consistent surface density in a banded pattern via a single nozzle.

Stated differently, a method of cigarette filter assembly may include steps of: assembling cigarette filter material into a generally cylindrical body; providing a ribbon of plug wrap material including a filter-facing surface; directing the plug wrap material past a hot melt adhesive applicator including at least one nozzle through which hot melt adhesive is dispensed (e.g., as dots, straight line(s), spiral(s) and/or other regular or irregular pattern(s) of application/dispensation); applying a first predetermined treatment quantity of a hot melt adhesive via at least one nozzle to the plug wrap material's filter-facing surface; and assembling the plug wrap material around the filter material, such that the filter-facing surface of the plug wrap material, treated with the hot melt adhesive, is directed against the filter material; wherein the first predetermined quantity of hot melt adhesive applied may dynamically be determined by an encoder that correlates the quantity of hot melt adhesive released to a speed at which the plug wrap material is directed past the at least one nozzle, where the encoder is in communication with the plug wrap material (or a source thereof) in a manner monitoring the rate at which the plug wrap material is directed past the hot melt applicator and is in communication with the hot melt adhesive applicator; and wherein the hot melt adhesive between the assembled plug wrap and filter material forms an effective barrier against passage of fluid from the filter material to the plug wrap. Thereafter, the plug-wrap-covered filter material may be cut at regular intervals to form cigarette filters, then assembled (e.g., by application of tipping paper) with a wrapped tobacco rod to form a cigarette.

Cigarette rods typically are manufactured using a cigarette making machine, such as a conventional automated cigarette rod making machine. Exemplary cigarette rod making machines are of the type commercially available from Molins PLC or Hauni-Werke Korber & Co. KG. For example, cigarette rod making machines of the type known as MkX (commercially available from Molins PLC) or PROTOS (commercially available from Hauni-Werke Korber & Co. KG) can be employed. A description of a PROTOS cigarette making machine is provided in U.S. Pat. No. 4,474,190 to Brand, at col. 5, line 48 through col. 8, line 3, which is incorporated herein by reference. Types of equipment suitable for the manufacture of cigarettes also are set forth in U.S. Pat. No. 4,781,203 to La Hue; U.S. Pat. No. 4,844,100 to Holznagel; U.S. Pat. No. 5,156,169 to Holmes et al.; U.S. Pat. No. 5,191,906 to Myracle, Jr. et al.; U.S. Pat. No. 6,647,870 to Blau et al.; U.S. Pat. No. 6,848,449 to Kitao et al.; and U.S. Pat. No. 6,904,917 to Kitao et al.; and U.S. Pat. Nos. 7,210,486 to Hartman; 7,275,548 to Hancock et al.; 7,281,540 to Barnes et al.; and 7,234,471 to Fitzgerald et al.; each of which is incorporated herein by reference.

The components and operation of conventional automated cigarette making machines will be readily apparent to those skilled in the art of cigarette making machinery design and operation. For example, descriptions of the components and operation of several types of chimneys, tobacco filler supply equipment, suction conveyor systems and garniture systems are set forth in U.S. Pat. No. 3,288,147 to Molins et al.; U.S. Pat. No. 3,915,176 to Heitmann et al; U.S. Pat. No. 4,291,713 to Frank; U.S. Pat. No. 4,574,816 to Rudszinat; U.S. Pat. No. 4,736,754 to Heitmann et al. U.S. Pat. No. 4,878,506 to Pinck et al.; U.S. Pat. No. 5,060,665 to Heitmann; U.S. Pat. No. 5,012,823 to Keritsis et al. and U.S. Pat. No. 6,360,751 to Fagg et al.; and U.S. Pat. App. Pub. No. 2003/0136419 to Muller; each of which is incorporated herein by reference. The automated cigarette making machines of the type set forth herein provide a formed continuous cigarette rod or smokable rod that can be subdivided into formed smokable rods of desired lengths.

Filtered cigarettes incorporating filter elements provided from filter rods that are produced in accordance with the present invention can be manufactured using traditional types of cigarette making techniques. For example, so-called “six-up” filter rods, “four-up” filter rods and “two-up” filter rods that are of the general format and configuration conventionally used for the manufacture of filtered cigarettes can be handled using conventional-type or suitably modified cigarette rod handling devices, such as tipping devices available as Lab MAX, MAX, MAX S or MAX 80 from Hauni-Werke Korber & Co. KG. See, for example, the types of devices set forth in U.S. Pat. No. 3,308,600 to Erdmann et al.; U.S. Pat. No. 4,281,670 to Heitmann et al.; U.S. Pat. No. 4,280,187 to Reuland et al.; and U.S. Pat. No. 6,229,115 to Vos et al.; and U.S. Pat. Nos. 7,435,585 to Holmes; 7,237,557 to Maiwald et al; and 7,296,578 to Read, Jr.; each of which is incorporated herein by reference. The operation of those types of devices will be readily apparent to those skilled in the art of automated cigarette manufacture.

Cigarette filter rods that are produced in accordance with the present invention can be used to provide multi-segment filter rods. Such multi-segment filter rods can be employed for the production of filtered cigarettes including multi-segment filter elements. An example of a two-segment filter element is a filter element including a first cylindrical segment incorporating activated charcoal particles (e.g., a “dalmation” type of filter segment) at one end, and a second cylindrical segment that is produced from a filter rod produced in accordance with embodiments of the present invention. The production of multi-segment filter rods can be carried out using the types of rod-forming units that have been employed to provide multi-segment cigarette filter components. Multi-segment cigarette filter rods can be manufactured using a cigarette filter rod making device available under the brand name Mulfi from Hauni-Werke Korber & Co. KG of Hamburg, Germany.

Various types of cigarette components, including tobacco types, tobacco blends, top dressing and casing materials, blend packing densities; types of paper wrapping materials for tobacco rods, types of tipping materials, and levels of air dilution, can be employed. See, for example, the various representative types of cigarette components, as well as the various cigarette designs, formats, configurations and characteristics, that are set forth in U.S. Pat. Nos. 5,220,930 to Gentry; 6,779,530 to Kraker; 7,237,559 to Ashcraft et al.; and 7,565,818 to Thomas et al.; and U.S. Pat. App. Pub. Nos. 2005/0066986 to Nestor et al.; and 2007/0246055 to Oglesby; each of which is incorporated herein by reference.

Filter rods can be manufactured pursuant to embodiments of the present invention using a rod-making apparatus, and an exemplary rod-making apparatus includes a rod-forming unit. Representative rod-forming units are available as KDF-2 and KDF-3E from Hauni-Werke Korber & Co. KG; and as Polaris-ITM Filter Maker from International Tobacco Machinery. Filter material, such as cellulose acetate filamentary tow, typically is processed using a conventional filter tow processing unit. For example, filter tow can be bloomed using bussel jet methodologies or threaded roll methodologies. An exemplary tow processing unit has been commercially available as E-60 supplied by Arjay Equipment Corp., Winston-Salem, N.C. Other exemplary tow processing units have been commercially available as AF-2, AF-3 and AF-4 from Hauni-Werke Korber & Co. KG. and as Candor-ITM Tow Processor from International Tobacco Machinery. Other types of commercially available tow processing equipment, as are known to those of ordinary skill in the art, can be employed. Other types of filter materials, such as gathered paper, nonwoven polypropylene web or gathered strands of shredded web, can be provided using the types of materials, equipment and techniques set forth in U.S. Pat. No. 4,807,809 to Pryor et al. and U.S. Pat. No. 5,025,814 to Raker. In addition, representative manners and methods for operating a filter material supply units and filter-making units are set forth in U.S. Pat. No. 4,281,671 to Bynre; U.S. Pat. No. 4,850,301 to Green, Jr. et al.; U.S. Pat. No. 4,862,905 to Green, Jr. et al.; U.S. Pat. No. 5,060,664 to Siems et al.; U.S. Pat. No. 5,387,285 to Rivers and U.S. Pat. No. 7,074,170 to Lanier, Jr. et al.

During use of a filter-making apparatus, a continuous length or web of filter material is supplied from a source such as a storage bale, bobbin, or the like. The continuous length of filter material is pulled through a gathering region of the rod-forming unit. The gathering region can have a tongue and horn configuration, a gathering funnel configuration, a stuffer or transport jet configuration, or other suitable types or combinations of gathering mechanisms. A tongue provides for further gathering, compaction, conversion or formation of a cylindrical composite of filter material into an essentially cylindrical (i.e., rod-like) shape whereby the continuously extending strands or filaments of the filter material extend essentially along the longitudinal axis of the cylinder so formed.

The filter material that has been compressed into a cylindrical composite is received further into a garniture region. That is, the cylindrical composite is fed into a wrapping mechanism, which includes an endless garniture conveyer belt. The garniture conveyer belt is continuously and longitudinally advanced using an advancing mechanism (not shown) such as a ribbon wheel or cooperating drum so as to transport the cylindrical composite through the wrapping mechanism. The wrapping mechanism provides and applies a ribbon of wrapping material, such as a web of porous or non-porous paper plug wrap, to the outer surface of the cylindrical composite in order to produce continuous wrapped rod.

The strip or web of wrapping material is provided from rotatable bobbin, or other suitable source. The wrapping material is drawn from the bobbin, is trained over a series of guide rollers, and enters the wrapping mechanism of the rod-forming unit. The endless garniture conveyer belt transports both the strip of wrapping material and the cylindrical composite downstream in a longitudinally extending manner through the wrapping mechanism while draping or enveloping the wrapping material about the cylindrical composite.

The seam formed by an overlapping marginal portion of wrapping material has adhesive (e.g., hot melt adhesive) applied thereto at applicator region in order that the wrapping material can form a tubular container for the filter material. Alternatively, the hot melt adhesive may be applied directly upstream of the wrapping material's entry into the garniture region of the wrapping mechanism. The adhesive can be cooled using a chill bar in order to cause rapid setting of the adhesive. It is understood that various other sealing mechanisms and other types of adhesives can be employed in providing the continuous wrapped rod. As such, there is provided a manner or method for supplying a continuous supply of plug wrap, circumscribing the longitudinal periphery of a continuous supplied filter material gathered composite, and hence forming a continuous filter rod circumscribed by plug wrap.

The continuous wrapped rod passes from the sealing mechanism and is subdivided (e.g., severed) at regular intervals at the desired, predetermined length using a cutting assembly, which includes as a rotary cutter, a highly sharpened knife, or other suitable rod cutting or subdividing mechanism. It is particularly desirable that the cutting assembly does not flatten or otherwise adversely affect the cross-sectional shape of the rod. As such, the filter material supplied to a filter-making unit is formed into a continuous rod, which is subdivided, using a rod cutting assembly, into a plurality of filter rods or rod portions. The succession or plurality of rod portions are collected for further use, using a tray, a rotary collection drum, conveying system, or the other suitable collection mechanism. If desired, the rod portions can be transported directly to a cigarette making machine.

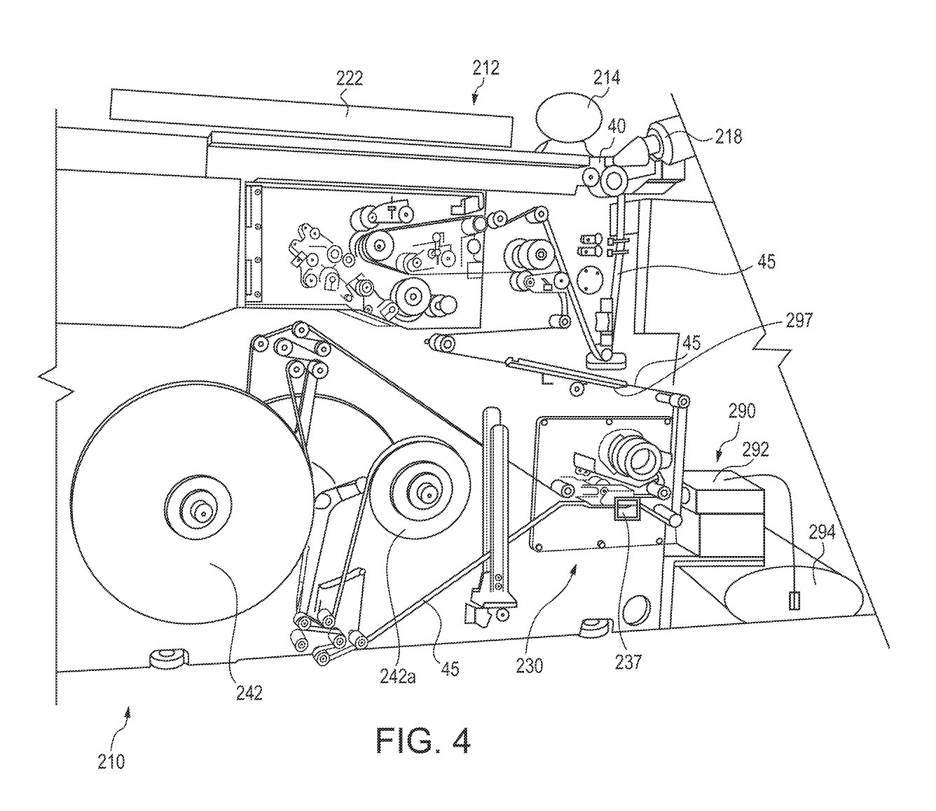

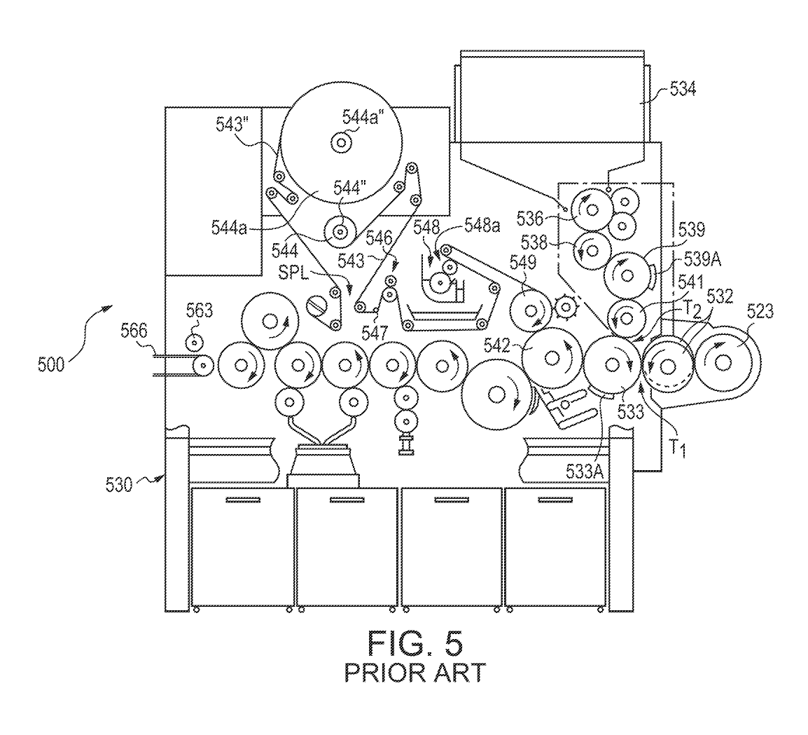

The foregoing description of a filter-making method may be understood with reference to FIG. 4, which illustrates that filter rods or filter rod portions, each incorporating an object, such as spherical, capsular, cylindrical (i.e., pellets), or other suitably shaped objects including strips, threads, or other shapes, can be manufactured using a filter rod-making apparatus 210. An exemplary filter rod-making apparatus 210 (e.g., a KDF-2 unit available from Hauni-Werke Korber & Co. KG) may include a rod-forming unit 212 suitably adapted to process a continuous length of filter material 40 into a continuous filter rod (not shown, but known in the art and readily understood with reference to, for example, U.S. Pat. Pub. No. 2011/0180084 to Sebastian, et al. and U.S. Pat. No. 7,972,254 to Stokes, et al., each of which is incorporated herein by reference). The continuous length or web of filter material is supplied from a source such as a storage bale, bobbin, spool or the like. Generally, the filter material 40 is processed using a filter material processing unit 218 and passed through the rod-forming unit 212 to form the continuous rod of filter material. An object insertion unit 214 may be associated with the rod-forming unit 212 to place/insert capsules or other objects (not shown) within the continuous length of filter material or the continuous filter rod. The continuous filter rod can then be subdivided using a rod cutting assembly within a larger garniture and processing assembly 222 into a plurality of rod portions each having at least one of the objects disposed therein. The succession or plurality of rod portions may then be collected for further processing in a collection device which may be a tray, a rotary collection drum, conveying system, or the like. If desired, the rod portions can be transported directly to a cigarette making machine. In such a manner, in excess of 500 rod portions, each of about 100 mm in length, can be manufactured per minute.

The filter material 40 can vary, and can be any material of the type that can be employed for providing a tobacco smoke filter for cigarettes. A traditional cigarette filter material may be used, such as cellulose acetate tow, gathered cellulose acetate web, polypropylene tow, gathered cellulose acetate web, gathered paper, strands of reconstituted tobacco, or the like. Filamentary tow such as cellulose acetate, polyolefins such as polypropylene, or the like may be preferred in some embodiments. One preferred filter material that can provide a suitable filter rod is cellulose acetate tow having 3 denier per filament and 40,000 total denier. As another example, cellulose acetate tow having 3 denier per filament and 35,000 total denier can provide a suitable filter rod. As another example, cellulose acetate tow having 8 denier per filament and 40,000 total denier can provide a suitable filter rod. For further examples, see the types of filter materials set forth in U.S. Pat. No. 3,424,172 to Neurath; U.S. Pat. No. 4,811,745 to Cohen et al.; U.S. Pat. No. 4,925,602 to Hill et al.; U.S. Pat. No. 5,225,277 to Takegawa et al. and U.S. Pat. No. 5,271,419 to Arzonico et al.

Filamentary tow, such as cellulose acetate, may be processed using a conventional filter tow processing unit 218 such as a commercially available E-60 supplied by Arjay Equipment Corp., Winston-Salem, N.C. Other types of commercially available tow processing equipment, as are known to those of ordinary skill in the art, may similarly be used. Normally a plasticizer such as triacetin is applied to the filamentary tow in traditional amounts using known techniques. Other suitable materials for construction of the filter element will be readily apparent to those skilled in the art of cigarette filter design and manufacture.

The continuous length of filter material 40 is directed into a gathering (garniture) region of the assembly 222, to form a cylindrical composite. The filter material 40, which has been compressed into the cylindrical composite, is continuously received into the rod-forming unit 212 to form the continuous filter rod. As noted above, in conjunction with the formation of the continuous filter rod, objects (such as, for example, breakable capsule containing a flowable material) may be inserted along the length of and within the web of filter material as that filter material is being formed into the continuous filter rod and/or after the filter material is formed into the continuous filter rod (i.e., at any point along the rod-forming unit 212 (or upstream or downstream thereof). However, the objects may also be introduced into the filter material at other points in the process and this exemplary embodiment is not intended to be limiting in that regard. In order to insert objects into the continuous filter rod, the rod-forming unit 212 may include an element-dividing mechanism (not shown) disposed upstream of the object insertion unit 214. In some instances, the element-dividing mechanism may be included in the object insertion unit 214 (or some portion thereof) itself.

The cylindrical composite is fed into the wrapping, processing, and cutting assembly 222, which may include an endless garniture conveyor belt or other garniture mechanism. The garniture conveyor belt transports the cylindrical composite of filter material 40 through the assembly. The wrapping mechanism portion of the assembly 222 provides a strip of the treated plug wrap material 45 to the outer surface of the cylindrical composite in order to produce a continuous wrapped filter rod.

Generally, the strip or web of plug wrap 45 is provided from a rotatable bobbin 242. The plug wrap is drawn from the bobbin (or a back-up bobbin 242a), is trained over a series of guide rollers and passes through a seamless-supply assembly 230 that maintains seamless continuation of supply between the bobbin and its back-up. The seamless-supply assembly 230 or another location on or in the device 210 may be equipped with a rotary encoder 237 or other device that mechanically and/or electronically detects the rate of supply of the plug wrap 45. The rotary encoder 237 is shown diagrammatically, but those of skill in the art will appreciate that a device providing its functionality may be located in any number of places in and/or on the apparatus 210. In the present apparatus 210, it is strongly preferable that the device 237 is in communication with the plug wrap or a feeding mechanism element for the plug wrap to measure the rate at which plug wrap is moving, and is in communication (e.g. electronic and/or mechanical communication) with the applicator 290 so that the amount of hot melt is correlated to the pace of plug wrap passing by the applicator such that the hot melt may be applied in a desired quantity and pattern.

The plug wrap 45 is directed past the hot melt adhesive applicator 290, which includes an applicator unit 292 and a supply container 294 of the hot melt adhesive. The applicator 290 (which may be embodied as, for example, a Baumer hhs Xmelt device) provides a finely controlled dispersion/application of hot melt adhesive through at least one nozzle onto a face of the plug wrap 45 (which comprises a surface that will face the filter material in an assembled filter plug). The applicator 290 preferably is in communication with the rotary encoder or other device 237 such that the amount of hot melt adhesive applied is correlated to the rate at which plug wrap is being supplied such that the plug wrap receives a consistent coating at a desired pattern and density. One preferred pattern is a band, which may be positioned to align with an underlying capsule and/or which may cover substantially all of a plug wrap surface; said band or other pattern may be provided by a single nozzle. Differently stated, a first predetermined quantity of hot melt adhesive applied may be dynamically determined by an encoder or other device 237 that correlates (with the applicator 290) the quantity of hot melt adhesive released to a speed at which the plug wrap material 45 is directed past the at least one applicator nozzle, where the encoder is in communication with the plug wrap material in a manner monitoring the rate at which the plug wrap material is directed past the hot melt applicator and is in communication with the hot melt adhesive applicator 290. Most preferably, the hot melt adhesive is applied in a pattern and quantity (such as will cover the entire surface either upon application and/or when pressed against/assembled to filter material) that will form an effective barrier against passage of fluid from the filter material to and/or through the plug wrap (e.g., in a filter containing one or more breakable capsules holding liquid, gel, or some other fluid/flowable material). Thereafter, the treated plug wrap 45 may be directed over a chill bar 297 to cool the adhesive, and then directed to the assembly 222 where it is applied around the filter material during garniture and other processing/assembly steps that may be completed in a manner similar or identical to that commonly in use in the art.

The seam formed by an overlapping marginal portion of wrapping material may includes adhesive (e.g., glue, hot melt adhesive) applied thereto at applicator region 244 in order that the wrapping material can form a tubular container for the filter material. Alternatively, the hot melt adhesive may be applied directly upstream of the wrapping material's entry into the garniture of the wrapping mechanism 234 or block 230, as the case may be. The adhesive can be cooled using chill bar 246 in order to cause rapid setting of the adhesive. It is understood that various other sealing mechanisms and other types of adhesives can be employed in providing the continuous wrapped rod.

In one aspect, a first predetermined quantity of a hot melt adhesive may be applied via at least one nozzle to at least one predetermined location upon the plug wrap filter-facing surface, where the first predetermined quantity of a hot melt is sufficient to adhere the plug wrap material 45 to the filter material 40. A second predetermined quantity of a hot melt or other adhesive may be applied via at least one nozzle to a second at least one predetermined location. The predetermined locations may include a seam line or any other region or pattern on the plug wrap surface. In another embodiment of a method of cigarette/filter assembly, the adhesive may be applied via the at least one nozzle to a surface of the filter material 40.

In certain embodiments, the first and/or second predetermined quantity and predetermined location of adhesive placement may be configured to form a barrier between the plug wrap material 45 and the filter 40. In embodiments of filters that include a breakable capsule or other object configured to release a flowable material, the barrier formed may be configured to prevent the flowable material from seeping, wicking, flowing, or otherwise traveling to and/or through the plug wrap. The predetermined location may be configured in a pattern that covers all or less than an entire surface area of the plug wrap. For example, the pattern may be disposed over a surface area of the plug wrap oriented about the breakable capsule and configured to prevent passage of the flowable material through the plug wrap.

The continuous wrapped rod passes from the sealing mechanism and is subdivided (e.g., severed) at regular intervals at the desired, predetermined length using a cutting portion of the assembly 222, which may include as a rotary cutter, a highly sharpened knife, or other suitable rod cutting or subdividing mechanism. It is particularly desirable that the cutting assembly does not flatten or otherwise adversely affect the cross-sectional shape of the rod. The rate at which the cutting assembly severs the continuous rod at the desired points may be controlled via an adjustable mechanical gear train (not shown), or other suitable mechanism. The rate at which the first and second objects are inserted into the continuous web of filter material/continuous filter rod is in a direct relationship to the speed of operation of the rod-making machine.

The object insertion unit 214 can be geared in a direct drive relationship to the drive assembly of the rod-making apparatus. Alternatively, the object insertion unit 214 can have a direct drive motor synchronized with the drive assembly of the rod-forming unit and feedback controlled by coupling with an object inspection mechanism to adjust the insertion unit drive assembly should the object insertion location shift out of position. In light of the relationship of the rate of object insertion and the rod-making machine, embodiments of the present invention are also directed to increasing the production rate of the rod-making machine without adversely affecting the object placement within the filter material.

The same or different apparatus and method may be used to apply a predetermined quantity and location for adhesive to attach tipping material to the plug wrap 45 and/or filter material 40 during assembly of a smoking article such as, for example, a cigarette.

FIG. 5 illustrates a prior art filter tipping machine 500. This machine may be directly coupled with a cigarette making machine. In addition to those referenced above, methods and devices for manufacturing filter cigarettes may be understood with reference to U.S. Pat. No. 7,117,871 to Hancock et al., which is incorporated herein by reference. It will be appreciated that the methods and components known in the art will readily be adapted by those having skill in the art to be integrated with the methods described herein, within the scope of the present disclosure. During the filter-making processes described above, and tipping processes described below, a “two-up” configuration is commonly used. That is, a double-length filter plug is formed, then a wrapped tobacco rod is attached to each end, after which the “two-up” cigarette formed thereby is cut across the middle of its length to form two cigarettes. The “two-up” intermediates and this method of manufacture are understood in the art, and may be appreciated with reference to, for example, U.S. Pat. No. 7,296,578 to Read, Jr. et al., which is incorporated herein by reference.

As shown in FIG. 5, a drum-shaped row forming conveyor 523 of a tobacco rod maker is mounted in the frame 530 of the filter tipping machine 500 and delivers paper-wrapped tobacco rods to two discrete rotary drum-shaped aligning conveyors 532. The conveyors 532 deliver the tobacco rods into successive flutes of a rotary drum-shaped assembly conveyor 533. The transfer station between the conveyors 532 and conveyor 533 is shown at T1. The conveyors 532 may be driven at different speeds and/or transport the respective rows of tobacco rods through different distances so that each flute of the assembly conveyor 533, which arrives at the transfer station T1 receives two tobacco rods (one from the first aligning conveyor 532 and the other from the second aligning conveyor 532). In manufacturing embodiments using a “two-up” configuration, the axial distance between the two rows of tobacco rods in the flutes of the conveyor 523 preferably is such that the tobacco rod pairs in the flutes of the assembly conveyor 533 are separated from each other by gaps having a width (as considered at right angles to the plane of FIG. 5) which at least equals the length of a filter plug of double unit length.

The frame 530 further supports a magazine 534 for a supply of filter rod sections (e.g., provided by the filter rod maker described herein with reference to FIG. 4, or another filter rod maker). The sections are stacked in the magazine 534 in such a way that their axes are normal to the plane of FIG. 5. The magazine 534 has an outlet which receives a portion of a rotary drum-shaped severing conveyor 536 having peripheral flutes which withdraw filter rod sections from the magazine 534 and transport them via a series of other roller components to a rotary drum-shaped accelerating conveyor 541, which inserts successive filter plugs into successive flutes of the assembly conveyor 533. The transfer station where such insertion takes place is shown at T2. Each filter plug is inserted in such a way that it is disposed in the gaps between coaxially adjacent tobacco rods.

The assembly conveyor 533 advances groups of three coaxial rod-shaped articles each (each such group including two wrapped tobacco rods of unit length and a filter plug of double unit length between the tobacco rods) between two stationary condensing cams 533A which cause the tobacco rods to move axially into actual contact with the adjacent ends of the respective filter plugs. The thus-condensed groups are delivered into successive flutes of a rotary drum-shaped transfer conveyor 542.

The frame 530 further supports two spindles 544′ and 544a′ for reels 544, 544a of tipping material. The reel 544 is the running or expiring reel; the web 543 which is stored thereon in withdrawn by two advancing rolls 546 and successive increments thereof may be passed over a curling tool 547. The leader of the fresh web 543″, which is stored on the reel 44a is located at a splicing station SPL and is preferably automatically attached to the adjacent portion of the running web 543 when the diameter of the expiring reel 544 is reduced to a predetermined value. Devices that can be used at the splicing station SPL to attach the leader of a fresh web to the running web are well-known and commonly used in the art.

The leader of the running web 543 adheres to the foraminous peripheral surface of a rotary conveyor here shown as a suction drum 549 which is adjacent to the transfer conveyor 542. During travel from the nip of the advancing rolls 546 to the peripheral surface of a suction wheel 549, successive increments of the tipping material web 543 advance along a paster unit 548 which uses rollers 548a to coat one side of the tipping material web 543 with a suitable adhesive. The web 543 is severed thereafter at regular intervals and attached to successive groups of coaxial rod-shaped articles on the transfer conveyor 542, preferably in such a way that the adhesive-coated side of tipping material 543 adheres to the corresponding filter plug and to the adjacent end portions of the unit length tobacco rods. Thereafter, the assembled smoking articles can be transported to a roller conveyor unit 63, 66 to exit the machine 500.

The prior art system 500 shown in FIG. 5 is generally efficient and effective, as evidenced by its continued use for thirty-plus years (and counting). However, the present inventors have developed an improvement that provides significant advantages and addresses a long-felt, but yet unmet, need. In the prior art system 500, the rollers 548a that are used to apply adhesive to the tipping material 543 often gather various particulates and materials present in the manufacturing environment. The presence of these particulates and materials can affect the efficiency of operation in several ways. The tipping paper 543 can become adhered to the rollers and/or otherwise be damaged by contact with the particulates and materials in the adhesive-coated rollers. The adhesive may not apply evenly and effectively to the tipping material 543, which may result in the assembled smoking articles being defective (because the tipping material does not properly secure to the wrapped tobacco rod and/or to the wrapped filter plug). To avoid these or other consequences, the system 500 must periodically be stopped so that the rollers 548a can be cleaned and/or replaced. This effectively stops production for an entire manufacturing line, and the down-time can be quite costly with respect to decreased product output and decreased productivity (of relevant personnel and machinery).

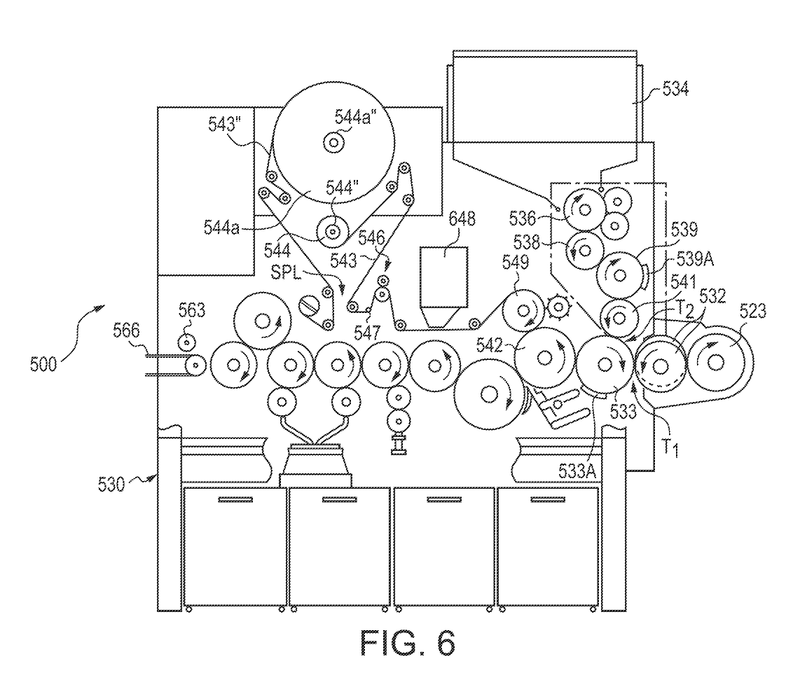

To address this need, a cold-glue applicator may be used to replace the paster assembly 548. A glue applicator gun 648 is shown in FIG. 6 as replacing the paster assembly 548, with all other components of the tipping paper application system 500 remaining the same as described above with reference to FIG. 5. Of course, it should be appreciated that other components and method steps associated with the system 500 may be altered without departing from the scope of the presently disclosed embodiments.

The glue applicator 648 may be embodied, for example, as a DF-500-5-SP (available from Baumer hhs). The glue applicator 648 may be mounted to supply glue to the surface of the tipping paper 43″. The applicator 648 includes at least one finely-controlled nozzle 649, which will provide adhesive to the tipping material 43″. The flow of adhesive through the nozzle 649 most preferably is finely controlled and is correlated to the rate at which tipping material is directed past the nozzle. As those of skill in the art will appreciate with reference to the present disclosure, this may be effected electronically and/or mechanically using, for example, a rotary encoder or other device. In this manner, as with the hot melt method described above, the flow rate of adhesive can be increased when the tipping material is passing more quickly past the at least one nozzle, and decreased when it is moving more slowly to make certain than a substantially uniform and effective amount of adhesive is provided on the tipping material surface. The nozzle(s) may be generally fixed or movable (which is also true for the hot melt applicator described above). The adhesive may be applied in a uniform or non-uniform pattern, and most preferably will be dispensed upon the surface in an amount and location(s) effective to adhere the tipping material to a filter plug at one end and a wrapped tobacco rod at the other, effectively connecting them together to form a smoking article. One preferred embodiment includes a band of adhesive applied by a single nozzle.

In order to accomplish this, the cold glue adhesive may be applied at an average surface density of about 0.7 mg/cm² to about 0.8 mg/cm², with some embodiments ranging from about 0.72 mg/cm² to about 0.81 mg/cm² and with one embodiment including average surface density of about 0.75 mg/cm². Expressed differently, the adhesive may be applied at a density of about 7 to about 8 mg per linear meter of tipping paper material, with one embodiment including a density of about 7.5 mg per linear meter of tipping paper material.

A method of tipping using this embodiment may include steps of: providing at least one filter plug and at least one wrapped tobacco rod; providing a ribbon of tipping material including an attachment surface; directing the tipping material past an adhesive applicator including at least one finely controlled nozzle through which adhesive is dispensed (e.g., as dots, straight line(s), spiral(s) and/or other regular or irregular pattern(s) of application/dispensation); applying a first predetermined treatment quantity of adhesive (e.g., cold glue) via the at least one nozzle to the tipping material's attachment surface; and assembling the tipping material around the filter plug and the at least one tobacco rod, such that the attachment surface of the tipping material contacts and connects the plug and the rod; wherein the first predetermined quantity of adhesive applied may dynamically be determined by an encoder device that correlates the quantity of adhesive released to a speed at which the tipping material is directed past the at least one nozzle, where the encoder is in communication with the tipping material in a manner monitoring the rate at which the tipping material is directed past the adhesive applicator and is in communication with the adhesive applicator. This communication may be accomplished electronically or mechanically (e.g., with a linkage or sensor to one or more spindles whose motion is tied to passage of material; with optical sensor(s)).

Suitable cold glue adhesives may include, for example, materials bearing National Starch code #20001812.

The glue applicator 648 may be provided in a generally closed environment that will prevent particulates and/or other material from contaminating the glue to be applied to the tipping paper material. It may also include temperature controls to maintain the temperature and viscosity of the glue within a desired range, in order to maximize effectiveness of the adhesive. Those of skill will readily appreciate a variety of structures and mechanisms, with reference to the present disclosure, to accomplish this. They will also appreciate that this method addresses a long-felt, but yet unmet need in the art to improve the efficiency of manufacture. Specifically, the nozzle-applied cold glue adhesive can be more carefully controlled in quantity and location of application than roller-applied adhesive (which has been the method in use for decades). This may result in cost-savings and material preservation efficiencies. In addition, the presently disclosed method and system will obviate the need for periodically stopping production to clean adhesive rollers that have been contaminated with particulates (which particulates may reduce effective adhesive application, damage tipping paper, etc.).

In one aspect that will readily be understood with reference to the present disclosure (including the incorporated art), the assembly method that include at least one filter-plug may include a “two-up” filter plug, where the at least one wrapped tobacco rod comprises two tobacco rods, and where each of the two tobacco rods is attached to an opposite end of the at least one filter plug. In such a method, the tipping paper material may encompassingly encircle the full length of the filter plug and cover a portion of each of the two tobacco rods sufficient to form attachment of each with the filter plug. Such a method may generally further include a step of cutting across a central portion of the at least one filter plug to form two smoking articles.

Those of skill in the art will appreciate that embodiments not expressly illustrated herein may be practiced within the scope of the present disclosure and claims, including that features described herein for different embodiments may be combined with each other and/or with currently-known or future-developed technologies while remaining within the scope of the claims presented here. The disclosure and claims are intended to cover methods and machinery for making smoking article components, and smoking articles made using the method(s) and/or machine(s). Although specific terms are employed herein, they are used in a generic and descriptive sense only and not for purposes of limitation. It is therefore intended that the foregoing detailed description be regarded as illustrative rather than limiting. And, it should be understood that the following claims, including all equivalents, are intended to define the spirit and scope of this invention. Furthermore, the advantages described above are not necessarily the only advantages of the embodiments described, and it is not necessarily expected that all of the described advantages will be achieved with every embodiment of the invention.

We claim:

1. A method of cigarette filter assembly, the method comprising steps of:
assembling cigarette filter material into a generally cylindrical body;
providing a ribbon of plug wrap material including a filter-facing surface;
directing the plug wrap material past a hot melt adhesive applicator including at least one nozzle through which hot melt adhesive is dispensed;
applying a first predetermined treatment quantity of a hot melt adhesive via at least one nozzle to the plug wrap material's filter-facing surface; and
assembling a plug wrap material around the filter material, such that the filter-facing surface of the plug wrap material, treated with the hot melt adhesive, is directed against the filter material;
and
wherein the hot melt adhesive between the assembled plug wrap and filter material forms an effective barrier against passage of fluid from the filter material to the plug wrap.

2. The method of claim 1, further comprising a step of cutting the plug-wrapped filter material at regular intervals to form cigarette filters.

3. The method of claim 2, further comprising a step of at least one of the cigarette filters to a tobacco rod to form a cigarette.

4. A cigarette incorporating a filter made according to claim 1.

5. The cigarette of claim 4, wherein the filter comprises a breakable capsule containing a flowable flavorant material.

6. The method of claim 1, where the hot melt adhesive is applied at a generally consistent surface density in a banded pattern.

7. The method of claim 1, where the hot melt adhesive is applied at a density of about 1.8 to about 2.2 grams per linear meter of plug wrap material.

8. The method of claim 1, where the hot melt adhesive is applied at a density of about 2 grams per linear meter of plug wrap material.

9. The method of claim 1, where the hot melt adhesive comprises a material bearing National Starch code 10110160.

10. The method of claim 1, wherein the first predetermined quantity of hot melt adhesive applied is dynamically determined by an encoder that correlates the quantity of hot melt adhesive released to a speed at which the plug wrap material is directed past the at least one nozzle, where the encoder is in communication with the plug wrap material in a manner monitoring the rate at which the plug wrap material is directed past the hot melt applicator and is in communication with the hot melt adhesive applicator.

11. A filter rod-making apparatus, further comprising a hot melt adhesive applicator including at least one nozzle through which hot melt adhesive is dispensed and configured to operate according to the method of claim 10.

12. A filter rod-making apparatus, further comprising a hot melt adhesive applicator including at least one nozzle through which hot melt adhesive is dispensed and configured to operate according to the method of claim 1.

13. A method of cigarette assembly for a capsule-equipped cigarette, the method comprising steps of:
assembling cigarette filter material into a generally cylindrical body including at least one breakable capsule within the cylindrical body configured to release a flowable material, said capsule disposed between fibers of the filter material;
assembling a plug wrap material around the filter material, where a filter-facing surface of the plug wrap will contact the filter material; and
applying a first predetermined quantity of a hot melt adhesive material via at least one nozzle in a pattern effective to form a fluid-resistant barrier to the flowable material upon the plug wrap filter-facing surface.

14. A smoking article manufactured according to the method of claim 13.

15. The method of claim 13, wherein the first predetermined quantity of hot melt adhesive applied is dynamically determined by an encoder that correlates the quantity of hot melt adhesive released to a speed at which the plug wrap material is directed past the at least one nozzle, where the encoder is in communication with the plug wrap material in a manner monitoring the rate at which the plug wrap material is directed past the hot melt applicator and is in communication with the hot melt adhesive applicator.
